(19) United States
(12) Patent Application Publication
(10) Pub. No.: US 2007/0008338 A1
(43) Pub. Date: Jan. 11, 2007

(54) Display system, display apparatus, and method of controlling video source and display apparatus

(76) Inventor: Young-chan Kim, Uiwang-si (KR)

Correspondence Address: STANZIONE & KIM, LLP, 919 18TH STREET, N.W., SUITE 440, WASHINGTON, DC, 20006, US

(21) Appl. No.: 11/431,837

(22) Filed: May 11, 2006

(30) Foreign Application Priority Data
May 28, 2005 (KR) 2005-45313
Jan. 23, 2006 (KR) 2006-6875

(51) Int. Cl. G09G 5/00

(52) U.S. Cl. 345/629

(57) ABSTRACT

A display system includes a video source to supply a first video signal and a display apparatus to receive the first video signal and a second video signal from an external device to be displayed as a main picture and a sub picture, respectively, through a picture in picture (PIP) processing. The display system further includes a controller which changes display area characteristics of at least one of a display area of a program active window of the main picture and a display area of the sub picture to remove an overlap area between the display areas of the program active window and the sub picture. Thus, the display system effectively deals with the overlap area without a user's key manipulation when the overlap area is generated while performing a picture in picture (PIP) function, a display apparatus of the display system controls the overlap area, and a control method controls the video source and the display apparatus to remove or prevent the overlap area.

### CROSS-REFERENCE TO RELATED APPLICATIONS

This application claims the benefit of Korean Patent Application No. 2005-0045313, filed on May 28, 2005, and Korean Patent Application No. 2006-0006875, filed on Jan. 23, 2006, in the Korean Intellectual Property Office, the disclosures of which are incorporated herein in its entirety by reference.

### BACKGROUND OF THE INVENTION

1. Field of the Invention

The present general inventive concept relates to a display system, and more particularly, to a display system which effectively controls an overlap area without a user's key manipulation when the overlap area is generated while performing a picture in picture (PIP) function, a display apparatus, and a control method of controlling a video source and the display apparatus.

2. Description of the Related Art

Generally, a display apparatus comprises an electrically erasable programmable read-only memory (EEPROM) which stores its specification, i.e., extended display identification data (EDID), therein to transmit the EDID to a video source, i.e., a computer through a display data channel (DDC) communication. Then, the computer receives the EDID and automatically displays an optimal picture within a range supported by the display apparatus, regardless of software used by a user.

Recently, the display apparatus supports a picture in picture (PIP) function which simultaneously displays two pictures in one monitor. Video signals which are input from two or more video sources are processed by the PIP function, and a main picture is displayed as a large picture and a sub picture is displayed in a 1/n size of the main picture, thereby displaying two different pictures on the monitor.

Typically, the display apparatus which supports the PIP function displays a PC video signal input from a computer graphic card as the main picture, and displays a video signal input from an external device, such as a TV or a VCR, as the sub picture, thereby enabling a user to view a TV program or movie from the TV and VCR while using the computer.

In a display system which comprises the computer, the external device, and the display apparatus supporting the PIP function, when the PC video signal is displayed as the main picture and the video signal from the external source is displayed as the sub picture, a PC program active window corresponding to the main picture overlaps a window corresponding to the sub picture while the user works on documents through the computer or executing a PC program such as the Internet.

FIG. 1 illustrates a conventional display system to control an overlap area 4 when a PC program active window 3 and a sub picture 2 overlap each other on a display part 5 of a display apparatus 10. In the conventional display system, a user manipulates a manipulation part 7 of the display apparatus 10 and adjusts a size of the sub picture 2 to a sub picture 2′ to remove the overlap area 4. Alternatively, a computer includes PC software to adjust a size of the PC program active window 3 to a second PC program active window 3′ by moving a cursor of a mouse in a direction of an arrow 4b or by using a keyboard (not shown), thereby removing the overlap area 4 in the conventional display system.

In the conventional display system, a user manipulates the manipulation part 7 of the display apparatus 10, or the mouse (not shown) and keyboard (not shown) of the computer to remove the overlap area 4 when the PC program active window 3 and the sub picture 2 overlap each other, thereby causing inconvenience to manipulate the sub picture 2 or the PC program active window 3.

### SUMMARY OF THE INVENTION

An aspect of the present general inventive concept provides a display system which effectively controls an overlap area without a user's key manipulation when the overlap area is generated while performing a picture in picture (PIP) function, a display apparatus, and a control method of a video source and the display apparatus.

Additional aspects and/or advantages of the present general inventive concept will be set forth in part in the description which follows and, in part, will be obvious from the description, or may be learned by practice of the present invention.

The foregoing and/or other aspects of the present general inventive concept may be achieved by providing a display system which comprises a video source to supply a first video signal, and a display apparatus to receive the first video signal and a second video signal from an outside of the display system to be displayed as a main picture and a sub picture, respectively, through a picture in picture (PIP) processing, the display system further comprising a controller which changes one or more display area characteristics of at least one of a first display area of a program active window of the main picture and a second display area of the sub picture and removes an overlap area between the display area of the program active window and that of the sub picture.

The controller may include a video source controller which is provided in the video source, request display area information of the sub picture to the display apparatus, and determine whether the overlap area exists by comparing the display area information of the sub picture and display area information of the program active window.

The controller may include a display controller which is provided in the display apparatus and supplies the display area information of the sub picture to the video source based on the PIP processing, when the request signal is received from the video source.

The display area characteristics may include at least one of a size and a position of the display area.

The controller may further include an overlap display improving function setter to set an overlap display improving function in an on state to improve a display of the overlap area, and determines whether the overlap area exists, and changes at least one of the display areas of the program active window and the sub picture when the overlap display improving function is set in the on state through the overlap display improving function setter.

The controller may further include a priority setter to set a priority of the program active window and the sub picture, and stores priority information of the set priority of the program active window and the sub picture.

The display apparatus may include a PIP processor which displays the first and second video signals as the main picture and the sub picture through the PIP processing, and the display controller may control the PIP processor to change a display area size of the sub picture according to a sub picture control signal, when the predetermined sub picture control signal is input from the video source.

The controller may further include a position moving function setter which sets a position moving function of the program active window and the sub picture in the on/off states, and stores on/off setting information of the position moving function set through the position moving function setter.

The main picture may include a frame area of the program active window which visually divides the program active window and a display area boundary thereof.

The foregoing and/or other aspects of the present general inventive concept may also be achieved by providing a display apparatus which receives a plurality of video signals and displays the video signals as a main picture and a sub picture through a picture in picture (PIP) processing, the display apparatus comprising a controller which supplies display area information of the sub picture based on the PIP processing to a video source supplying at least one of the video signals to be displayed as the main picture, and changes at least one of a position and a size of the display area of the sub picture according to a sub picture control signal when the sub picture control signal is input from the video source.

The video source and the controller may communicate with each other through a display data channel (DDC) communication line.

The controller may further include a priority setter to set a priority of a program active window of the main picture and the sub picture, and stores priority information on the set program active window and the sub picture.

The controller may further include a position moving function setter to set a position moving function of the program active window of the main picture and the sub picture in on/off states, and stores on/off setting information on the position moving function set through the position moving function setter.

The foregoing and/or other aspects of the present general inventive concept may also be achieved by providing a method of controlling a video source which supplies a first video signal, and a display apparatus which receives the first video signal from the video source and a second video signal from an external device to display the first and second video signals through a picture in picture (PIP) processing, the method comprising displaying the first and second video signals as a main picture and a sub picture through a picture in picture (PIP) processing, and changing display area characteristics of at least one of a display area of a program active window of the main picture and a display area of the sub picture to remove an overlap area between the display area of the program active window and the display area of the sub picture.

The method may further include requesting display area information of the sub picture by the video source, and determining whether the overlap area exists by comparing the display area information of the sub picture and display area information of the program active window based on the first video signal supplied to the display apparatus.

The method may further include supplying the display area information of the sub picture based on the PIP processing to the video source when the request signal is received from the video source.

The method may further include receiving and storing priority information of the program active window and the sub picture, and the changing of the at least one of the display areas of the program active window and the sub picture may further include changing the display area of one of the program active window and the sub picture which does not have a priority with respect to the other one of the program active window and the sub picture based on the stored priority information, when the overlap area exists.

The method may further include setting a position moving function of the program active window and the sub picture in on/off states, and the changing of the at least one of the display areas of the program active window and the sub picture may include controlling one of a video signal supply of the video source and a PIP processor which performs the PIP processing, to move a display area position of one of the program active window and the sub picture which does not have a priority with respect to the other one of the program active window and the sub picture based on the priority information and to remove the overlap area, when the overlap area exists and the position moving function is set in the on state.

The method may further include requesting display area information of the program active window to the video source, and determining whether the overlap area exists by comparing the display area information of the program active window received from the video source and display area information of the sub picture.

The video source may include a video signal supply which outputs the first video signal, and the determining of the existence of the overlap area may include receiving the display area information of the program active window supplied by the video source which has received the request signal, based on the video signal supply.

The program active window of the main picture may include a frame area of the program active window which visually divides a display area boundary of the program active window, and the sub picture may include a second frame area of the sub picture which visually divides a second display area boundary of the sub picture.

The foregoing and/or other aspects of the present general inventive concept may also be achieved by providing display system comprising a controller to automatically change a characteristic of one of a main picture and a sub picture to be displayed on a screen according to a priority on the main picture and the sub picture.

The foregoing and/or other aspects of the present general inventive concept may also be achieved by providing display system comprising a controller to change a characteristic of one of a main picture and a sub picture to be displayed on a screen according to a priority on the main picture and the sub picture, a position moving setting, and a determination of whether an overlap area exists between the main picture and the sub picture.

The foregoing and/or other aspects of the present general inventive concept may also be achieved by providing display system comprising a processing unit to receive a first signal and a second signal to generate a main picture and a sub picture from the first signal and the second signal, respectively, to be displayed on a screen, and a controller to change at least one display area characteristic of at least one of a display area of the main picture and a display area of the sub picture with respect to the screen to remove an overlap area between the display areas of the program active window and the sub picture.

The foregoing and/or other aspects of the present general inventive concept may also be achieved by providing display system comprising a processing unit to receive a first signal and a second signal to generate a main picture and a sub picture from the first signal and the second signal to be displayed on a first position and a second position of a screen, respectively, and a controller to determines whether there is an overlap area between the first position and the second position, to change at least one of the first position and the second position into a third position according to the determination of whether there is the overlap area, and to control the processing unit to generate the main picture and the sub picture to be displayed on corresponding ones of the changed one of the first position and the second position and the other one of the first position and the second position.

The foregoing and/or other aspects of the present general inventive concept may also be achieved by providing display system comprising a display part having a screen, a processing unit to receive a first signal and a second signal, and to determine a first portion of the screen and a second portion of the screen to correspond to the first signal and the second signal, and a controller to determine an overlap area between the first portion and the second portion, to determine a third portion of the screen to correspond to one of the first portion and the second portion, and to generate a main picture and a sub picture according to the first signal, the second signal, and the third portion of the screen.

The foregoing and/or other aspects of the present general inventive concept may also be achieved by providing display system comprising a host to generate a first signal, and a display apparatus having a processing unit to receive the first signal input from the host and a second signal input from an external device to generate a main picture and a sub picture from the first signal and the second signal, respectively, to be displayed on a screen, and having a controller to change at least one of display area characteristics of at least one of a display area of the main picture and a display area of the sub picture with respect to the screen to remove an overlap area between the display areas of the program active window and the sub picture.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates an overlap area between a program active window and a sub picture which are displayed in a conventional display system;

FIG. 2 is a control block diagram illustrating a display system according to an embodiment of the present general inventive concept;

FIG. 3 is a control block diagram illustrating a display system according to an embodiment of the present general inventive concept;

FIGS. 4 and 5 are control flowcharts illustrating a method of the display system of FIG. 2;

FIG. 6 is a control flowchart illustrating an operation of determining whether an overlap area exists in the method of the display system of FIG. 4;

FIGS. 7 and 8 are control flowcharts illustrating a method of the display system of FIG. 3;

FIG. 9 is a control flowchart illustrating an operation of determining whether an overlap area exists in the method of the display system of FIG. 7;

FIGS. 10A, 10B, and 10C are views illustrating a display system to move and change a sub picture according to an embodiment of the present general inventive concept;

FIGS. 11A, 11B, and 11C are views illustrating a display system to move and change a program active window according to an embodiment of the present general inventive concept;

FIG. 12 is a view illustrating frame areas of a sub picture and a program active window in a display system according to an embodiment of the present general inventive concept; and

FIG. 13 is a control flowchart illustrating a method of a display apparatus according to an embodiment of the present general inventive concept.

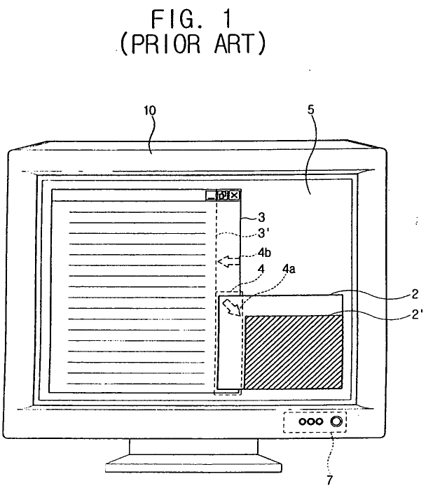

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present general inventive concept by referring to the figures.

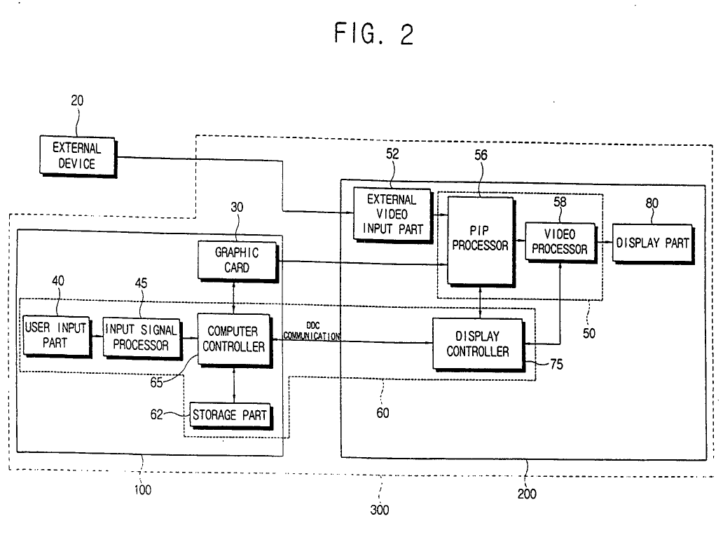

As illustrated in FIG. 2, a display system 300 according to an embodiment of the present general inventive concept comprises a computer 100 as a first video source which supplies a first video signal, and a display apparatus 200 which receives the first video signal from the computer 100 and a second video signal from an external device 20 as a second video source to display the first and second video signals as a main picture and a sub picture, respectively, on a screen of the display apparatus 200 through a PIP processing. The display apparatus 200 includes an external video input part 52 to receive the second video signal from the external device 20, a processing part 50 having a PIP processor 56 and a video processor 58 to process the first and/or second video signals, a display part 80 to display the processed first and/or second video signals, and a display controller 75.

The computer 100 and the display apparatus 200 comprise a controller 60 which determines whether an overlap area exists between a first display area of the main picture and a second display area of the sub picture, and changes at least one of the first and second display areas of the PC program active window and the sub picture to remove the overlap area when the overlap area exists. When a window is generated from the computer 100 as the main picture to be displayed in the first display area of the screen of the display apparatus 200, the window is referred to as a program active window or a personal computer (PC) program active window to be displayed on a portion of the screen of the display apparatus 200. Also, the PC program active window may include a sub window having icons corresponding to manipulation keys to control an image displayed in the PC program active window, and a second sub window having a sub screen to display the image. The second sub window may be disposed on an area surrounded with the sub window. When the computer 100 and the display apparatus 200 may be formed in a single body, such as a portable computer or a laptop computer in which the display apparatus 200 may be rotatably connected to the computer 100, the single body of the portable computer or the laptop computer includes a memory unit disposed therein to generate a signal as one of the first and second video signals of the first and second video sources. That is, the first video signal or the second video signal may be generated from the memory unit and connected to the display controller 75 or the PIP processor 56 so that the signal corresponding to the first video signal or the second video signal is supplied to the PIP processor 56 as the main picture (the program active window) or the sub picture.

The controller 60 comprises a computer controller 65 which is provided in the computer 100, requests display area information of the sub picture to the display apparatus 200, and determines whether the overlap area exists by comparing display area information of the PC program active window based on the first video signal supplied to the display apparatus 200 and the display area information of the sub picture supplied from the display apparatus 200 corresponding to the request, a storage part 62 and a user input part 40, and a display controller 75 which is provided in the display apparatus 200 to supply the requested display area information of the sub picture based on the PIP processing to the computer 100 when receiving a request signal from the computer 100. The computer controller 65 may communicate with the display controller 75 through a display data channel (DDC) communication line.

Referring to FIG. 2, the computer 100 as the first video source which supplies the first video signal to the display apparatus 200 comprises a graphic card 30 as a video signal supply which supplies the first video signal (hereinafter, to be referred to as PC video signal) to the display apparatus 200. A user inputs a command or an input signal through the user input part 40 such as a mouse (not shown) and a keyboard (not shown). An input signal processor 45 processes the input signal input through the user input part 40. The storage part 62 stores information therein. The computer controller 65 controls overall operations of the computer 100 according to the input signal from the input signal processor 45 and/or the user input part 40. The overall operation may include executing a PC program according to the input signal from the input signal processor 45 and controlling the graphic card 30 to supply the PC video signal to display an active window of the executed PC program on the display apparatus 200.

The user input part 40 comprises an overlap display improving part which is provided to set an overlap display improving function as an on state and to improve a display of the overlap area, a position moving function setter which sets a position moving function of the PC program active window and the sub picture as on/off states, and a priority setter which sets a priority of the PC program active window and the sub picture. Here, the overlap display improving function may be set as an on state through a state adjustment UI menu which is displayed on the display apparatus 200 by using the mouse, may be set as the on state by double clicking one of the PC program active window and the sub picture displayed on the display apparatus 200 or may be set by using a tray icon of the Windows of the display apparatus 200.

The computer controller 65 controls the overall operations of the computer 100 according to the input signal input from the user input part through the input signal processor 45.

The computer controller 65 may control the storage part 62 to store priority information of the PC program active window and the sub picture set through the user input part 40, and on/off setting information of the position moving function of the PC program active window and the sub picture set through the user input part 40.

The computer controller 65 determines whether the overlap display improving function is set as the on state through the user input part 40 to improve a display state of the overlap area by reducing or preventing the overlap area. When the overlap display improving function is set as the on state, the computer controller 65 requests the display area information of the sub picture to the display apparatus 200. When the display apparatus 200 supplies the display area information of the sub picture corresponding to the request, the computer controller 65 determines whether the overlap area exists between the received display area information of the sub picture and the display area information of the PC program active window. The computer controller 65 may have the display area information of the PC program active window which is generated from the graphic card 30 of the computer 100 or may receive the display area information of the PC program active window from the display apparatus 200 which displays the PC program active window. The computer controller 65 may determine the existence of the overlap area by comparing respective display pixel information of the display area information of the sub picture, and the display area information of the PC program active window detected from the graphic card 30 and by determining whether the sub picture and the PC program active window have the same display area (display pixel) on the screen of the display apparatus 100.

As the computer controller 65 communicates with the display controller 75 through the DDC communication line, the computer controller 65 may determine whether the display apparatus 200 currently performs a PIP function. Thus, even when the overlap display improving function is set as the on state through the user input part 40, the computer controller 65 may not request the display area information of the sub picture and may not determine whether the overlap area exists when the display apparatus 200 does not perform the PIP function.

When it is determined that the overlap area exists based on a determination result, the computer controller 65 recognizes a priority of the sub picture and the PC program active window and the on/off state of the position moving function based on the information of the storage part 62.

When it is determined that the position moving function is set as the on state and the sub picture has the priority with respect to the PC program active window, the computer controller 65 controls the graphic card 30 to remove the overlap area by moving a display area position of the PC program active window or changing a size of the PC program active window to be displayed on the screen of the display apparatus 200. When it is determined that at least one portion of the previously-existed overlap area still exists even after moving the display area position of the PC program active window, the computer controller 65 controls the graphic card 30 to remove the at least one portion of the overlap area by changing the display area size of the moved PC program active window. Here, the overlap display improving function setter, the priority setter, and the position moving function setter may be a functional configuration (e.g., software) functionally comprised of the controller 60 instead of a hardware configuration comprised of the user input part 40. In other words, all of the functions of the overlap display improving function setter, the priority setter, and the position moving function setter are performed by the controller 60. Also, it is preferred that the functions of the overlap display improving function setter, the priority setter, and the position moving function setter are performed by the computer controller 65 of the controller 60.

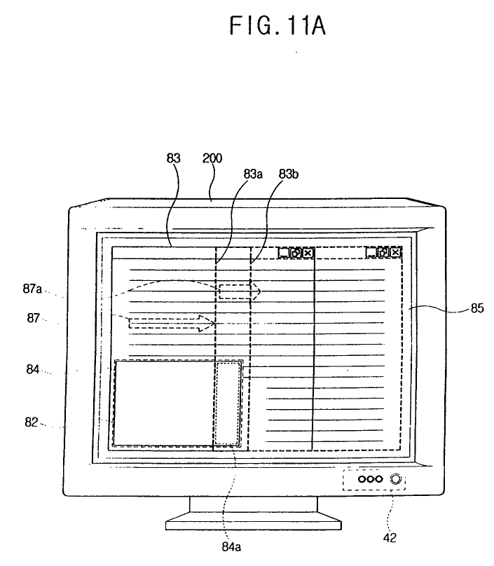

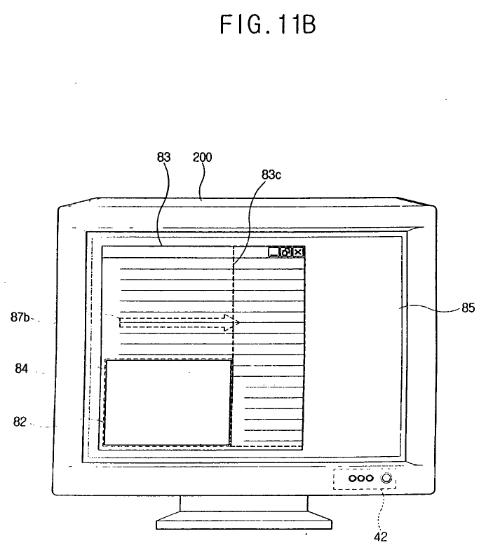

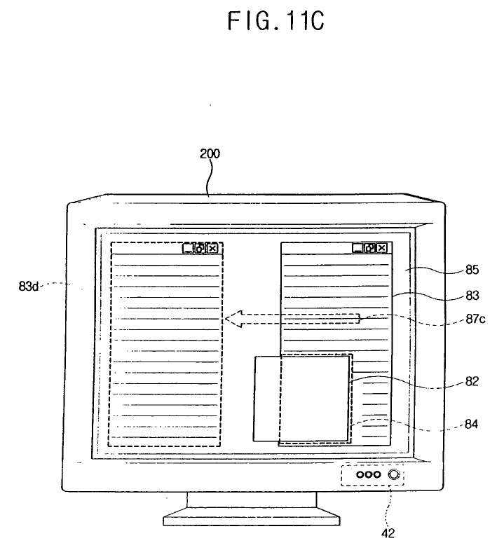

That is, the computer controller 65 controls the graphic card 30 to change the display position and size of the PC program active window not to overlap the display area of the sub picture, based on display pixel information of a displayable area of the display apparatus 200 and a display area (display pixel information) of the sub picture, instead of changing the display area of the sub picture. Such an operation will be described with reference to FIGS. 11A through 11C.

Referring to FIGS. 2, 11A, 11B, and 11C, when the second video signal is input from the external device 20 and the display apparatus 200 performs the PIP function, the display part 80 of the display apparatus 200 displays a PC video 85 having a PC program active window 83 as the main picture, and a sub picture 82 corresponding to the second video signal thereon. As illustrated in FIG. 11A, the sub picture 82 is included in the PC program active window 83 and a display area of the sub picture 82 becomes an overlap area 84. In this case, the display area of the sub picture 82 may be identical to the overlap area 84. When the overlap display improving function is set as the on state by a user, and the PC program active window 83 does not have a priority with respect to the sub picture 82, a display position or a display area of the PC program active window is moved in a direction of an arrow 87 to a second display position (second display area) that is not included in the display area of the sub picture 82 within the displayable area of the display apparatus 200 such that the second display position of the PC program active window does not overlap the display area of the sub picture 82, and the moved PC program active window moved to the second display position of the displayable area of the display apparatus 200 is displayed as a second PC program active window 83a. A reference numeral 42 denotes one or more keys or buttons which are formed on a housing of the display apparatus 200 to control functions of the display apparatus 200. Since the keys 42 are connected to the display controller 75, a user may control an operation of moving, adjusting, and changing at least one of the sub picture 82 and the PC program active window 83 to remove the overlap area 84 by manipulating the keys 42.

When the PC program active window does not have the priority with respect to the sub picture 82, the display position of the second PC program active window 83 is moved, and the overlap area does not exist between the sub picture 82 and the second PC program active window 83a, a display size of the second PC program active window 83a does not change.

However, as shown therein, a second overlap area 84a may still exist between a portion of the second display area of the second PC program active window 83a and a portion of the display area of the sub picture 82. Then, the second PC program active window 83a is adjusted in a direction of an arrow 87a to a third display portion or a third display area which is not included in the display area of the sub picture 82 within the displayable area of the display apparatus 200, so that the third display area does not overlap the display area of the sub picture 82, and the moved second PC program active window is displayed as a third PC program active window 83b.

When the PIP function is performed and the overlap display improving function is set as the on state by a user while the overlap area 84 exists between the portions of the sub picture 82 and the PC program active window 83 (refer to FIG. 11C), the PC program active window 83 which doe not have the priority with respect to the sub picture 82 is moved in a direction of an arrow 87c to a new display area that is not included in the display area of the sub picture 82 within the displayable area of the display apparatus 200, so that the new display area does not overlap the display area of the sub picture 82, and the PC program active window 83 moved to the new display area is displayed as a fourth PC program active window 83d.

When it is determined that the position moving function is set as an off state and the sub picture 82 has a priority with respect to the PC program active window 83 based on the recognition result of the priority and the on/off state of the position moving function, the computer controller 65 controls the graphic card 30 to change a display area size of the PC program active window 83 to remove the overlap area 84.

That is, the computer controller 65 controls the graphic card 30 to change the display area size of the PC program active window 83 with respect to the displayable area of the screen of the display apparatus 200 not to overlap the display area of the sub picture 82, instead of changing the display area of the sub picture 82. Such an operation will be described with reference to FIG. 11B.

As illustrated in FIG. 11B, when the PIP function is performed to display the sub picture 82 and the PC program active window 83 within the displayable area of the screen of the display apparatus 200, the overlap display improving function is set as the on state by a user, and the PC program active window 83 does not have the priority with respect to the sub picture 82, the PC program active window 83 is moved in a direction of an arrow 87b to a new display area that is not included in the display area of the sub picture 82, so that the new display area does not overlap the display area of the sub picture 82, and the PC program active window 83 moved to the new display area is displayed as a fifth PC program active window 83c.

When it is determined that the position moving function is set as the on state and the PC program active window 83 has the priority with respect to the sub picture 82, the computer controller 65 outputs a sub picture control signal to the display apparatus 200 to move the display area position of the sub picture 82 with respect to the sub picture 82 or the displayable area of the display apparatus 200, so that the overlap area 84 is removed or prevented. When a portion of the overlap area 84 still exists even after moving the display area position of the sub picture 82, the computer controller 65 outputs the sub picture control signal to the display apparatus 200 to change a display area size of the moved sub picture 82, thereby removing or preventing the overlap area 84. Alternatively, the computer controller 65 may output the sub picture control signal to the display apparatus 200 to move the display area position of the sub picture 82 with respect to the displayable area of the display apparatus 200 and to change the display area size thereof simultaneously, so that the overlap area is prevented or removed, based on the respective display area information on the overall displayable area of the display apparatus 200, the sub picture 82 and the PC program active window 83.

That is, the computer controller 65 outputs the sub picture control signal to the display apparatus 200 to move the display area of the sub picture 82 and change the display area size thereof not to overlap the display area of the PC program active window 83 based on display pixel information on the overall displayable area of the display apparatus 200 and the display area (display pixel information) of the PC program active window 83, without changing the display area of the PC program active window 83.

When it is determined that the position moving function is set as the off state and the PC program active window 83 has the priority with respect to the sub picture 82, the computer controller 65 outputs the sub picture control signal to the display apparatus 200 to change the display area size of the sub picture 82 and to remove the overlap area 84. That is, the computer controller 65 outputs the sub picture control signal to the display apparatus 200 to change the display area size of the sub picture 82 not to overlap the display area of the PC program active window 83, based on the display pixel information of the overall displayable area of the display apparatus 200 and the display area (display pixel information) of the PC program active window 83.

Here, when the position moving function is set as the off state and the overall display area of one of the PC program active window 83 and the sub picture 82 is included in the display area of the other, the computer controller 65 preferably does not perform the operation (ex. controlling the graphic card 30 or outputting the sub picture control signal to deal with the overlap area) according to the present invention.

Referring back to FIG. 2, in the display apparatus 200, the external video input part 52 receives the second video signal from the external device 20, the PIP processor 56 processes the PC video signal input from the computer 100 and the second video signal input through the external video input part 52 to display the PC video signal and the second video signal as the main picture and the sub picture, respectively, on the display part 80 through the PIP processing, the video processor 58 processes the video signals processed by the PIP processor 56 to be displayed on the display part 80, and the display controller 75 supplies the display area information of the sub picture 82 to the computer 100 based on the PIP processing of the PIP processor 56 when receiving the request signal from the computer 100.

When the PIP function is performed, the display controller 75 controls the PIP processor 56 to display the first video signal (the PC video signal) as the main picture and display the second video signal from the external source 20 as the sub picture. As the display controller 75 communicates with the computer controller 65 through the DDC communication line, the display controller 75 may inform the computer controller 65 that the PIP function is being performed.

When the request signal is input from the computer controller 65 to request the display area information of the sub picture 82, the display controller 75 supplies the display area information of the sub picture 82, to the computer controller 65, based on the PIP processing of the PIP processor 56. Then, the display controller 75 determines whether the computer controller 65 outputs the sub picture controller signal to perform at least one of moving the display area position of the sub picture 82 with respect to the PC program active window and/or the displayable area of the display apparatus 200 and changing the display area size thereof. When the sub picture control signal is input, the display controller 75 controls the PIP processor 56 to move and/or change at least one of the display position and size of the sub picture 82 according to the sub picture control signal.

Here, the sub picture control signal is output from the computer controller 65 to perform at least one of moving the display area position and changing the display area size of the sub picture 82 which does not have the priority with respect to the PC program active window 83 not to overlap the display area of the PC program active window 83, based on the display pixel information of the overall displayable area of the display apparatus 200 and the display area (display pixel information) of the PC program active window 83, without changing the display area of the PC program active window 83. The display pixel information and the display areas of the sub picture and the PC program active window 83 may be represented by coordinates, for example, two dimensions, two axes, or horizontal and vertical directions of the screen of the display apparatus 200.

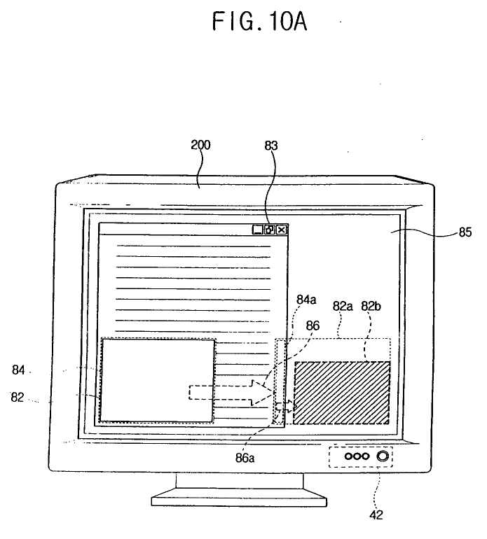

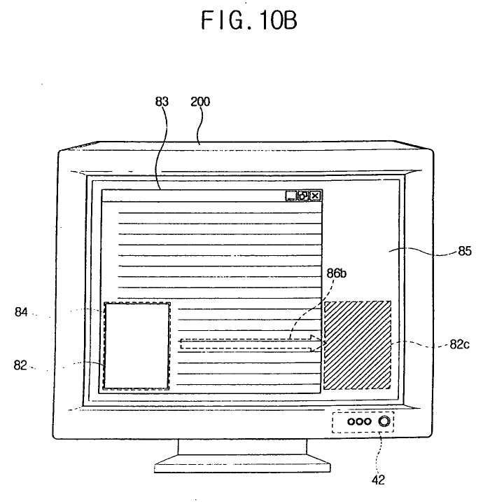

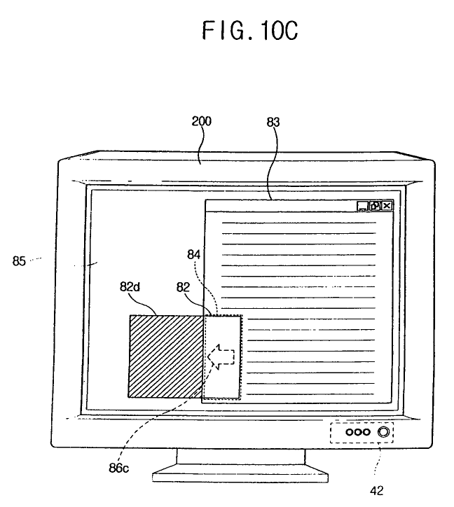

Referring to FIGS. 2, 10A, 10B, and 10C, an operation of moving and/or changing at least one of the display position and the display size of a sub picture 82 of the display apparatus 200 according to the sub picture control signal input from the computer 100 will be described. When the PIP function is executed, the display part 80 of the display apparatus 200 displays a PC video 85 having a PC program active window 83 of the main picture, and displays the sub picture 82. As illustrated in FIG. 10A, the sub picture 82 may be included in the PC program active window 83, and the overall display area of the sub picture 82 can have an overlap area 84 with the PC program active window 83. The PC video 85 may have a first portion in which the PC program active window is disposed to display an image corresponding to the first video signal, and a second portion in which the PC program active window is not disposed. Here, FIGS. 10A and 10B illustrate the display apparatus 200 when the position moving function is set as the on state while FIG. 10C illustrates the display apparatus 200 when the position moving function is set as the off state.

As illustrated in FIGS. 2 and 10A, when it is determined that the position moving function is set as the on state, and the PC program active window 83 has a priority with respect to the sub picture 82, the display controller 75 receives the sub picture control signal from the computer controller 65. The display controller 75 controls the PIP processor 56 to move and/or change the display position and the display size of the sub picture 82 with respect to the PC program active window 83 or the displayable area of the display apparatus according to the sub picture control signal. That is, the sub picture 82 is moved in a direction of an arrow 86 to a second display area which is not included in the display area of the PC program active window 83 within the overall displayable area of the display apparatus 200, so that the second display area of the sub picture 82 does not overlap the display area of the PC program active window 83 according to the sub picture control signal, and the sub picture 82 is displayed as a second sub picture 82a. However, as illustrated in FIG. 10A, a portion of the overlap area 84a may still exist as a portion of the second display area of the moved sub picture 82a overlaps a portion of the display area of the PC program active window 83. Then, the moved second sub picture 82a may be adjusted in a direction of an arrow 86a to a third display area which is not included in the display area of the PC program active window 83 within the overall displayable area of the display apparatus 200, the third display area does not overlap the display area of the PC program active window 83 according to the sub picture control signal, and the sub picture 82 is displayed as a third sub picture 82b.

Referring to FIG. 10B, when it is determined that the position moving function is set as the on state and the PC program active window has the priority with respect to the sub picture 82, the display controller 75 receives the sub picture control signal from the computer controller 65. Then, the sub picture 82 is moved in a direction of an arrow 86b to a fourth display area which is not included in the display area of the PC program active window 83 within the overall displayable area of the display apparatus 200, so that the fourth display area does not overlap the display area of the PC program active window 83 according to the sub picture control signal, and the sub picture 82 is displayed as a fourth sub picture 82c. When the display position of the sub picture 82 which does not have the priority with respect to the PC program active window 83 is moved to remove the overlap area 84 between the PC program active window 83 and the moved fourth sub picture 82c, the display size of the fourth sub picture 82c does not change.

As illustrated in FIG. 10C, when the PIP function is executed, the overlap area 84 may still exist as a portion of the sub picture 82 overlaps the PC program active window 83. When it is determined that the position moving function is set as the off state and the PC program active window 83 is prior to the sub picture 82, the display controller 75 receives the sub picture control signal from the computer controller 65. Then, the display controller 75 controls the PIP processor 56 to change the display size of the sub picture 82, according to the sub picture control signal. That is, the sub picture 82 is moved, changed, or adjusted in a direction of an arrow 86c to a fifth display area which is not included in the display area of the PC program active window 83, so that the fifth display area does not overlap the display area of the PC program active window 83 according to the sub picture control signal, and the sub picture 82 is displayed as a fifth sub picture 82d. It is possible that when the display size of the sub picture 82 is adjusted, at least one of a characteristic or attribute of the sub picture 82, such as a resolution of the sub picture 82 and/or a ratio of a width and a height of the sub picture 82 may be changed.

In the foregoing embodiment, the display apparatus 200 displays the main picture and a single sub picture, but not limited thereto. Alternatively, a plurality of sub pictures may be displayed, and priorities of the PC program active window as the main picture and the plurality of the sub pictures may be stored. The priorities can be determined by the computer controller 65, the display controller 75. A user may input the priorities through one or more keys 42 and/or the user input part 40. Also, the display position and the display size of the PC program active window 83 and the sub pictures 82 may be differently adjusted according to the priorities.

When the external device 20 comprises a broadcasting station, the second video signal may comprise a broadcasting signal. When the external device 20 comprises a video player, the second video signal may comprise a video signal which is reproduced from a recording medium in the video player. When the external device 20 comprises a communication network for a video phone, the second video signal may comprise a video signal which corresponds to a person talking over the video phone. When the external device 20 is a device connected to the external video input part 52 through Internet, the second video signal may comprise a video signal transmitted through the Internet. That is, the external video input part 52 may be variously provided to receive the video signal from the various external devices 20. Also, the second video signal may vary in format according to a kind of the external device 20.

FIGS. 10A through 11C illustrate the PC program active window 83 and the sub picture 82 which do not comprise a frame area dividing a display area boundary thereof. However, the PC program active window 83 of the main picture may further comprise a frame area which visually divides or indicates the display area boundary of the PC program active window 83. The sub picture 82 may further comprise a frame area which visually divides or indicates the display area boundary of the sub picture 82.

When the PC program active window 83 of the main picture comprises the display area and the frame area thereof, and when the sub picture 82 comprises the display area and the frame area thereof, it may be determined that an area where the frame area of the PC program active window 83 overlaps the frame area of the sub picture 82 is not included in the overlap area 84. Also, it may be determined that an area where the frame area of the PC program active window 83 overlaps the display area of the sub picture 82, and an area where the display area of the PC program active window 83 overlaps the frame area of the sub picture 82 are not included in the overlap area 84. As an actual video supplied to a user is not displayed on the frame area of the PC program active window 83 or the sub picture 82, a user can watch the video without difficulty even when the frame areas of the PC program active window 83 and the sub picture 82 overlap. The overlap area 84 may include portions of the display area and the frame area or may include portions of the frame area. As described above, when the portions of the frame areas overlap and portions of the display areas do not overlap, it is possible to determine that there is no overlap area.

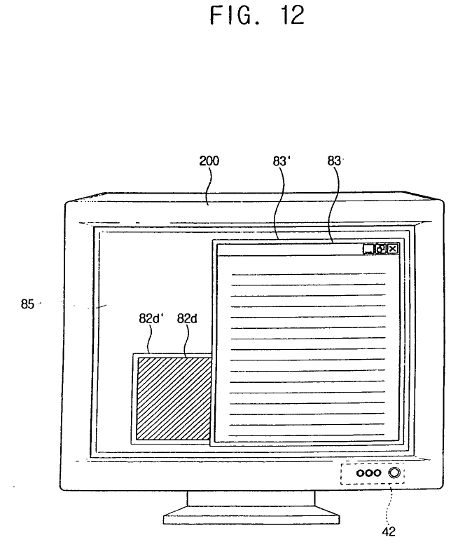

FIG. 12 is a view illustrating display areas and frame areas of the PC program active window 83 as the main picture and the sub picture 82.

Referring to FIG. 2, 10A through 11C, and 12, the overlap area 84 is removed by changing the sub picture 82 which dose not have the priority with respect to the PC program active window 83. Here, a display area corresponding to the PC program active window 83 and a frame area 83′ indicating a boundary of the display area of the PC program active window 83 which has the priority with respect to the sub picture 82 do not change. Instead, a display area 82d and a frame area 82d′ of the sub picture 82 are changed (refer to FIG. 10C). When the frame area 82d′ of the sub picture 82 overlaps the frame area 83′ of the PC program active window 83, the area where the frame area 83′ of the PC program active window 83 overlaps the frame area 82d′ of the sub picture 82 may not be determined as the overlap area 84. Accordingly the sub picture 82 may be changed (moved or adjusted) until the frame area 83′ of the PC program active window 83 overlaps the frame area 82d′ of the sub picture 82.

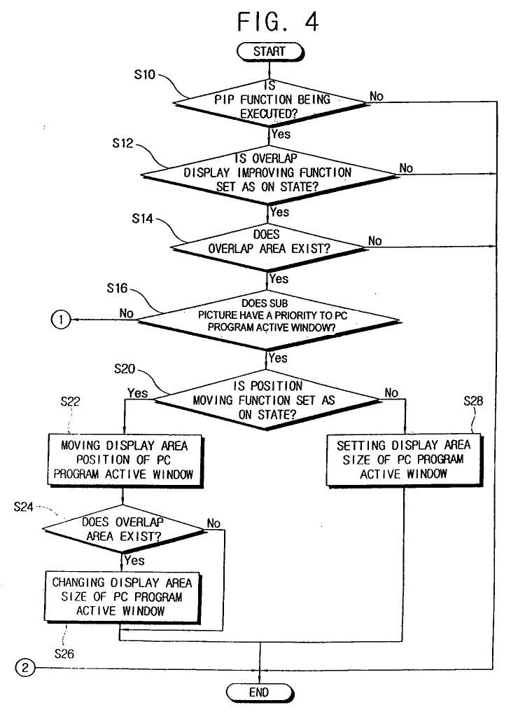

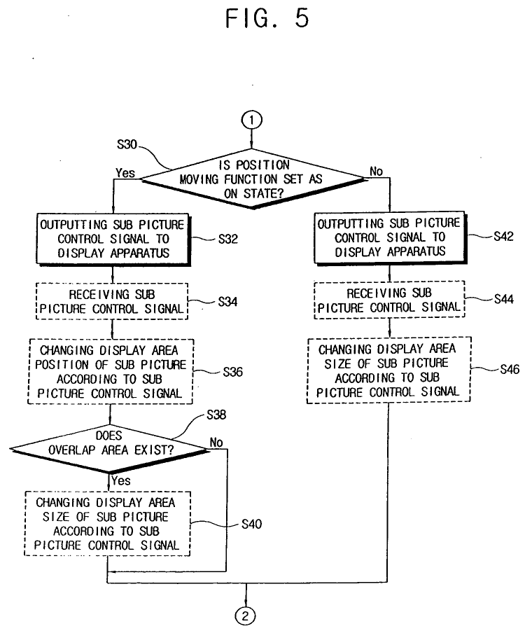

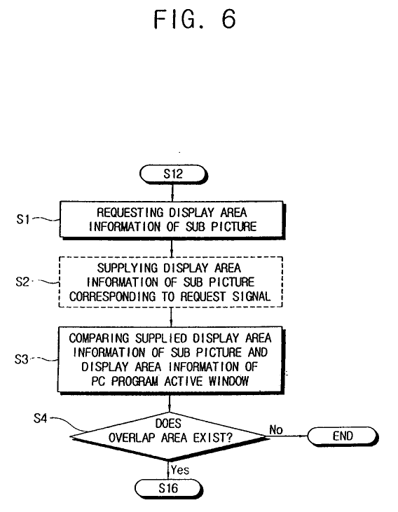

FIGS. 4 and 5 are control flowcharts illustrating a method of the display system 300 of FIG. 2, and FIG. 6 is a control flowchart illustrating an operation of determining whether an overlap area exists in the method of the display system of FIG. 4. For purposes of convenience, a control operation of the computer 100 is illustrated as a solid line, and a control operation of the display apparatus 200 is illustrated as a dotted line.

Referring to FIGS. 2, 4, 5, and 6, the computer controller 65 determines whether the display apparatus 200 performs (executes) the PIP function through communication with the display controller 75 at operation S10. When it is determined that the display apparatus 200 performs the PIP function, the computer controller 65 determines whether the overlap display improving function is set as the on state through the user input part 40 at operation S12. When it is determined that the overlap display improving function is set as the on state based on the determination result of the operation S12, the computer controller 65 determines whether the overlap area 84 exists between the PC program active window 83 and the sub picture 82 at operation S14. Referring to FIG. 6, the operation S14 of determining the existence of the overlap area will be described in detail.

When the overlap display improving function is set as the on state while performing the PIP function, the computer controller 65 requests the display area information of the sub picture 82 to the display apparatus 200 at operation S1. The display controller 75 supplies the display area information of the sub picture 82 to the computer controller 65 corresponding to the request at operation S2. Then, the computer controller 65 compares the respective display pixel information of the received display area information of the sub picture 82 and the display area information of the PC program active window 83 at operation S3. The display area information of the PC program active window 83 can be detected from the graphic card 30 by the computer controller 65 or the display controller 75. The computer controller 65 determines whether the overlap area 84 exists between the sub picture 82 and the PC program active window 83 having the same display area (display pixel), based on the comparison result of the operation S3, at operation S4.

When it is determined that the overlap area 84 exists at operation S14, the computer controller 65 determines whether the sub picture 82 has the priority with respect to the PC program active window 83 based on the information stored in the storage part 62 at operation S16. When the sub picture 82 has the priority with respect to the PC program active window 83, the computer controller 65 determines whether the position moving function is set as the on state based on the information of the storage part 62 at operation S20. When the position moving function is set as the on state, the computer controller 65 may control the graphic card 30 to move the display area position of the PC program active window 83 to remove the overlap area 84 at operation S22. Then, the computer controller 65 determines whether a portion of the overlap area 84 still exists between the moved PC program active window 83 and the sub picture 82 at operation S24. When it is determined that the overlap area still exists, the computer controller 65 controls the graphic card 30 to change (adjust) the display area size of the moved PC program active window 83 to remove the portion of the overlap area 84 at operation S26.

Here, when it is determined that the position moving function is set as the off state at the operation S20, the computer controller 65 controls the graphic card 30 to change (adjust) the display area size of the PC program active window 83 to remove the overlap area 84 at operation S28.

Meanwhile, when it is determined that the sub picture 82 does not have priority with respect to the PC program active window 83 at the operation S16, operations of FIG. 5 are performed through connections \textcircled{1} and \textcircled{2}. That is, the computer controller 65 determines whether the position moving function is set as the on state based on the information of the storage part 62 at operation S30. When the position moving function is set as the on state, the computer controller 65 outputs the sub picture control signal to the display apparatus 200 to move the display area position of the sub picture 82 to remove the overlap area 84 based on the display pixel information of the overall displayable area of the display apparatus 200 and the display area (display pixel information) of the PC program active window 83 at operation S32. Then, the display controller 75 receives the sub picture control signal at operation S34 and controls the PIP processor 56 to move the display area position of the sub picture 82 according to the received sub picture control signal at operation S36. The computer controller 65 determines whether a portion of the overlap area 84 still exists between the moved sub picture 82 and the PC program active window 83 at operation S38. When it is determined that the overlap area 84 still exists, the computer controller 65 outputs the sub picture control signal to the display apparatus 200 to change the display area size of the sub picture 82 to remove the overlap area 84. The display controller 75 controls the PIP processor 56 to change the display area size of the sub picture 82 according to the sub picture control signal received from the computer controller 65 at operation S40.

Here, when it is determined that the position moving function is set as the off state at the operation S30, the computer controller 65 outputs the sub picture control signal to the display apparatus 200 to change the display area size of the sub picture 82 to remove the overlap area 84 based on the display pixel information of the overall displayable area of the display apparatus 200 and the display area (display pixel information) of the PC program active window 83 at operation S42. Then, the display controller 75 receives the sub picture control signal at operation S44, and controls the PIP processor 56 to change the display area size of the sub picture 82 according to the received sub picture control signal at operation S46.

Here, FIG. 6 illustrates the operation S14 which is performed between the operations S12 and S16. The operations S24 and S38 of FIG. 5 may be performed through the operations S1 to S4 in FIG. 6.

As described above, the display system 300 and a control method thereof, and the computer 100 and the display apparatus 200 included in the display system 300 according to the present general inventive concept may effectively remove the overlap area 84 between the PC program active window 83 and the sub picture 82 through a simple manipulation (i.e., setting the overlap display improving function as the on state), without one or more key inputs by a user to control the overlap area 84.

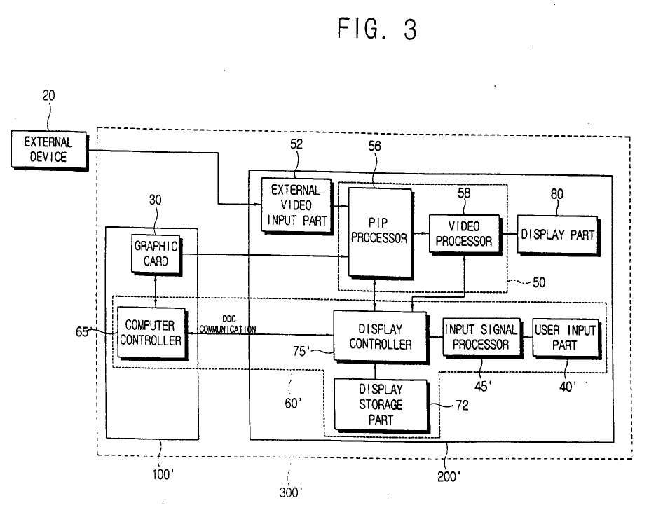

As illustrated in FIG. 3, a display system 300′ according to an embodiment of the present general inventive concept comprises a computer 100′ as a video source which supplies a first video signal, and a display apparatus 200′ which receives the first video signal from the computer 100′ and a second video signal from an external device 20 to display the first video signal and the second video signal as a main picture and a sub picture, respectively, on a screen of the display apparatus 200′ through a PIP processing. The PIP processing may be performed in a processing part 50. The computer 100′ and the display apparatus 200′ comprise a controller 60′ which determines whether an overlap area exists between a display area of the main picture and a display area of the sub picture, and changes the display area of at least one of the main picture and the sub picture to remove or prevent the overlap area when the overlap area exists. Here, since the first video signal may be a signal generated from a program (or PC program) of the computer 100′ to display an image or a text, the main picture is referred to as the image or the text as an output of the program (or PC program). Accordingly, the display area of the main picture is referred to as a program active window (PC program active window).

The controller 60′ comprises a computer controller 65′ which is provided in the computer 100′ and supplies display area information of the PC program active window based on the first video signal transmitted to the display apparatus 200′, to the display apparatus 200′, a display controller 75′ which is provided in the display apparatus 200′ and compares the display area information of the PC program active window received from the computer 100′ and display area information of the sub picture to determine whether the overlap area exists, a display storage part 72, an input signal processor 45′, and a user input part 40. The computer controller 65′ communicates with the display controller 75′ through a DDC communication line.

Hereinafter, the display system 300′ according to the present embodiment will be described in detail.

The display apparatus 200′ receives the first video signal (hereinafter, to be referred to as a PC video signal) from the computer 100′ as a video source. The display apparatus 200′ comprises a display part 80, an external video input part 52 which receives the second video signal from the external device 20, a PIP processor 56 which receives the PC video signal from the computer 100′ and the second video signal input through the external video input part 52 to display the PC video signal and the second video signal as the main picture and the sub picture, respectively, through the PIP processing, a video processor 58 which processes the video signal processed by the PIP processor 56 to be displayed on the display part 80, a user input part 40′ which is provided to input a command by a user such as a manipulation key (not shown) or a remote control (not shown) provided on a casing of the display apparatus 200′, an input signal processor 45′ which processes an input signal (or the command) input through the user input part 40′, the display storage part 72 which stores information therein, and the display controller 75′ which controls the overall operations of the display apparatus 200′ according to the input signal input from the input signal processor 45′ to control the PIP processor 56 and the video processor 58 to perform the PIP function.

The user input part 40 comprises an overlap display improving part which is provided to set an overlap display improving function as an on state and to improve a display of the overlap area or prevent the overlap area, a position moving function setter which sets a position moving function of the PC program active window and the sub picture as on/off states, and a priority setter which sets a priority of the PC program active window and the sub picture. Here, the overlap display improving function may be set as the on state through a state adjustment user interface (UI) menu which is displayed on the display apparatus 200′ by using a manipulation key (not shown) or a remote controller (not shown). The user may set the overlap display improving function by double clicking one of the PC program active window and the sub picture displayed on the display apparatus 200′ or set by using a tray icon of the Windows. The state adjustment UI menu may be generated from one of the computer controller 65′ and the display controller 75′ to be displayed on the screen of the display part 80.

The display controller 75′ controls the overall operations of the display apparatus 200′ according to the input signal input from the user input part 40′ through the input signal processor 45′. The display controller 75′ controls the display part 72 to store priority information of the PC program active window and the sub picture set through the user input part 40′, and on/off setting information of the position moving function of the PC program active window and the sub picture set through the user input part 40′.

The display controller 75′ determines whether the overlap display improving function is set as the on state to improve the display of the overlap area, through the user input part 40′. When the overlap display improving function is set as the on state, the display controller 75′ requests the display area information of the PC program active window to the computer 100′. When the computer 100′ supplies the display area information of the PC program active window corresponding to the request, the display controller 75′ determines whether the overlap area exists between the display area information of the PC program active window and the display area information of the sub picture. The display controller 75′ may determine the existence of the overlap area by comparing respective display pixel information of the display area information of the PC program active window, and the display area information of the sub picture detected from the PIP processor 56 and by determining whether the sub picture and the PC program active window have the same display area (display pixel). It is possible that the display controller 75′ may obtain the display area information of the PC program active window from the first video signal and/or the key manipulation of the user input part 40′. It is also possible that the display controller 75′ may calculate the display pixel information of the display area information of the PC program active window using coordinates of the screen of the display part 80.

When the computer 100′ periodically supplies the display area information of the PC program active window, the display controller 75′ may periodically receive the display area information of the PC program active window from the computer 100′, instead of requesting the display area information of the PC program active window to the computer 100′. When the display area information of the PC program active window is periodically input, the display controller 75′ determines whether the overlap area exists in a case that the overlap display improving function is set as the on state through the user input part 40′ to improve the display of the overlap area.

Thus, even when the overlap display improving function is set as the on state through the user input part 40′, the display controller 75′ may not request the display area information of the PC program active window and may not determine whether the overlap area exists, based on the periodically-input display area information of the PC program active window received when the display apparatus 200′ does not currently perform the PIP function.

When it is determined that the overlap area exists based on the above determination result, the display controller 75′ recognizes the priority of the sub picture and the PC program active window and the on/off setting state of the position moving function based on information stored in the display storage part 62.

When it is determined that the position moving function is set as the on state and the PC program active window has the priority with respect to the sub picture, the display controller 75′ controls the PIP processor 56 to move a display area position of the sub picture to remove or prevent the overlap area. When it is determined that at least a portion of the overlap area still exists even after moving the display area position of the sub picture, the display controller 75′ controls the PIP processor 56 to change a display area size of the moved sub picture to remove or prevent the overlap area. Here, the overlap display improving function setter, the priority setter, and the position moving function setter may be a functional configuration (e.g., software) functionally comprised of the controller 60′ instead of a hardware configuration comprised of the user input part 40′. In other words, all of the functions of the overlap display improving function setter, the priority setter, and the position moving function setter are performed by the controller 60′. Also, it is preferred that the functions of the overlap display improving function setter, the priority setter, and the position moving function setter are performed by the computer controller 75′ of the controller 60′.

That is, the display controller 75′ controls the PIP processor 56 to change the display area position and size of the sub picture not to overlap the display area of the PC program active window, based on the display pixel information of an overall displayable area of the display apparatus 200′ and the display area (display pixel information) of the PC program active window, without changing the display area of the PC program active window. The above operation will be described with reference to FIGS. 10A and 10B.

Referring to FIGS. 3, 10A, and 10B, when the PIP function is executed, the display part 80 of the display apparatus 200′ displays a PC video 85 having a PC program active window 83 of the main picture, and a sub picture 82 on a screen thereof. As illustrated in FIGS. 10A and 10B, the sub picture 82 is included in the PC program active window 83, and an entire portion of the display area of the sub picture 82 becomes an overlap area 84.

Referring to FIG. 10A, when it is determined that the position moving function is set as the on state and the PC program active window 83 has the priority with respect to the sub picture 82, the sub picture 82 is moved in a direction of an arrow 86 to a second display area that may not be included in the display area of the PC program active window 83 within the overall displayable area of the display apparatus 200′ by a control of the display controller 75′, and is displayed as a second sub picture 82a. However, as illustrated therein, a second overlap area 84a may still exist when a portion of the display area of the moved sub picture 82a overlaps a portion of the display area of the PC program active window 83. Thus, the moved sub picture 82a is adjusted in a direction of an arrow 86a to a third display area not included in the display area of the PC program active window 83 not to overlap the display area of the PC program active window 83, and the sub picture 82 is displayed as a third sub picture 82b.

Referring to FIG. 10B, when it is determined that the position moving function is set as the on state and the PC program active window has the priority with respect to the sub picture, the sub picture 82 is moved in a direction of an arrow 86b to a display area that is not included in the display area of the PC program active window 83 within the overall displayable area of the display apparatus 200′, and the sub picture 82 is displayed as a fourth sub picture 82c. When the overlap area does not exists between the PC program active window 83 and the moved sub picture 82c by moving the display position of the sub picture 82 which does not have the priority with respect to the PC program active window 83, the display size of the sub picture 82c does not change. It is possible that the sub picture 82 is moved to a space between a boundary of the PC program active window 83 and a boundary of the displayable area of the screen of the display part 80. Depending on a size of the space and an overlap between the moved sub picture 82 and the PC program active window 83, the moved sub picture 82 may be adjusted in size or location.

When it is determined that the position moving function is set as the off state and the PC program active window 83 has the priority with respect to the sub picture 82 based on a recognition result of the priority and the on/off setting state of the position moving function, the display controller 75′ controls the PIP processor 56 to change the display area size of the sub picture 82 to remove the overlap area.

That is, the display controller 75′ changes the display size of the sub picture 82 not to overlap the display area of the PC program active window 83 based on the display pixel information of the overall displayable area of the display apparatus 200′ and the display area (display pixel information) of the PC program active window 83, without changing the display area of the PC program active window 83. The above operation will be described with reference to FIG. 10C.

When the PIP function is executed, the display part 80 of the display apparatus 200′ displays the PC video 85 having the PC program active window 83 as the main picture, and displays the sub picture 82. As illustrated in FIG. 10C, the overlap area 84 may exist when a portion of the sub picture 82 overlaps the PC program active window 83.

When it is determined that the position moving function is set as the off state and the PC program active window 83 has the priority with respect to the sub picture 82, the sub picture 82 is adjusted in a direction of an arrow 86c to a fifth display area that is not included in the display area of the PC program active window 83 not to overlap the display area of the PC program active window 83, and the sub picture 82 is displayed as a fifth sub picture 82d.

When it is determined that the position moving function is set as the on state, and the sub picture 82 has the priority with respect to the PC program active window 83, the display controller 75′ outputs a PC active window control signal to the computer 100′ to move the display area position of the PC program active window 83, thereby removing or preventing the overlap area. When the overlap area still exists even after moving the display area position of the PC program active window 83, the display controller 75′ outputs the PC active window control signal to the computer 100′ to change a display area size of the moved PC program active window 83 to remove the overlap area. Alternatively, the display controller 75′ may output the PC active window control signal to the computer 100′ to move the display area position and change the display area size of the PC program active window 83 simultaneously and to remove the overlap area, based on the respective display area information of the overall displayable area of the display apparatus 200′, the sub picture 82 and the PC program active window 83.

The display controller 75′ outputs the PC active window control signal to the computer 100′ to move the display area of the PC program active window 83 and change the display area size thereof not to overlap the display area of the sub picture 82 based on the display pixel information of the overall displayable picture of the display apparatus 200′ and the display area (display pixel information) of the sub picture, without changing the display area of the sub picture 82.

When it is determined that the position moving function is set as the off state and the sub picture 82 has the priority with respect to the PC program active window 83, the display controller 75′ outputs the PC active window control signal to the computer 100′ to change the display area size of the PC program active window 83 to remove the overlap area. That is, the display controller 75′ outputs the PC active window control signal to the computer 100′ to change the display area size of the PC program active window 83 not to overlap the display area of the sub picture 82, based on the display pixel information of the overall displayable area of the display apparatus 200′ and the display area (display pixel information) of the sub picture 82.

Here, when the position moving function is set as the off state, and the overall display area of one of the PC program active window 83 and the sub picture 82 is included in the display area of the other one of the PC program active window 83 and the sub picture 82, the display controller 75′ may not perform an operation of moving one of the PC program active window 83 and the sub picture 82 according to the present embodiment. That is, the display controller 75′ may not perform controlling the PIP processor 56 or outputting the PC active window control signal corresponding to the overlap area.

The computer 100′ as the first video source supplies the first video signal to the display apparatus 200′. The computer 100′ comprises a graphic card 30 as a video signal supply which supplies the first video signal (hereinafter, to be referred to as PC video signal) to the display apparatus 200′; and the computer controller 65′ which controls the overall operations of the computer 100′, and recognizes the display area information of the PC program active window 83 transmitted from the graphic card 30 to output the PC program active window 83 and/or the display area information to the display controller 75′.

The computer controller 65′ controls the overall operations of the computer 100′ such as executing a PC program according to a user's selection. When a request signal is input from the display controller 75′ to request the display area information of the PC program active window 83, the computer controller 65′ recognizes the display area information of the PC program active window 83 from the graphic card 30 based on the PC video signal supplied to the display apparatus 200′ through the graphic card 30 and outputs the display area information of the PC program active window 83 to the display apparatus 200′. Alternatively, the computer controller 65′ may periodically recognize the display area information of the PC program active window 83 from the graphic card 30 and periodically output the display area information to the display apparatus 200′. As the computer controller 65′ communicates with the display controller 75′ through the DDC communication line, the computer controller 65′ may determine whether the PIP function is currently executed in the display apparatus 200′. According to a determination of whether the PIP function is currently executed in the display apparatus 200′, the computer controller 65′ periodically outputs the display area information of the PC program active window 83 to the display apparatus 200′.

The computer controller 65′ determines whether the display controller 75′ outputs the PC active window control signal to perform at least one of moving the display area position and changing the display area size of the PC program active window 83. When the PC active window control signal is input, the computer controller 65′ controls the graphic card 30 to move and/or change at least one of the display area position and size of the PC program active window 83 according to the PC active window control signal.

Here, the PC active window control signal is output from the display controller 75′ to perform at least one of moving the display area position and changing the display area size of the PC program active window 83 not to overlap the display area of the sub picture 82, based on the display pixel information of the overall displayable area of the display apparatus 200′ and the display area (display pixel information) of the sub picture 82, without changing the display area of the sub picture 82.

Referring to FIGS. 11A to 11C, an operation of moving and/or changing at least one of the display area position and the display area size of the PC program active window 83 according to the PC active window control signal input from the display apparatus 200′ will be described.

Referring to FIG. 11A, when it is determined that the position moving function is set as the on state and the sub picture 82 has the priority with respect to the PC program active window 83, the computer controller 65′ receives the PC active window control signal from the display controller 75′. The computer controller 65′ controls the graphic card 30 to move and/or change the display area position and the display area size of the PC program active window 83 according to the PC active window control signal. That is, the PC program active window 83 is moved in a direction of an arrow 87 to a second display area which is not included in the display area of the sub picture 82 within the overall displayable area of the display apparatus 200′ not to overlap the display area of the sub picture 82 according to the PC active window control signal, and the PC program active window 83 is displayed as a second PC program active window 83a. However, as illustrated in FIG. 11A, an overlap area 84a may still exist when a portion of the display area of the second PC program active window 83a overlaps a portion of the display area of the sub picture 82. Then, the second PC program active window 83a may be adjusted in a direction of an arrow 87a to a third display area which is not included in the display area of the sub picture 82 within the overall displayable area of the display apparatus 200′ not to overlap the display area of the sub picture 82 according to the PC active window control signal, and the PC program active window 83 is displayed as a third PC program active window 83b.

Referring to FIG. 11C, when it is determined that the position moving function is set as the on state and the sub picture has the priority with respect to the PC program active window, the computer controller 65′ receives the PC active window control signal from the display controller 75′. Then, the PC program active window 83 is moved in a direction of an arrow 87c to a fourth display area which is not included in the display area of the sub picture 82 within the overall displayable area of the display apparatus 200′ not to overlap the display area of the sub picture 82 according to the PC active window control signal, and the PC program active window 83 is displayed as a fourth PC program active window 83d. When the display position of the PC program active window 83 which does not have the priority with respect to the sub picture 82 is moved to remove the overlap area between the sub picture 82 and the fourth PC program active window 83d, the display area size of the fourth PC program active window 83d does not change.

Referring to FIG. 11B, when it is determined that the position moving function is set as the off state and the sub picture 82 has the priority with respect to the PC program active window 83, the computer controller 65′ receives the PC active window control signal from the display controller 75′. Then, the computer controller 65′ controls the graphic card 30 to change the display area size of the PC program active window 83 according to the PC active window control signal. That is, the PC program active window 83 is moved in a direction of an arrow 87b to a fifth display position which is not included in the display area of the sub picture 82 not to overlap the display area of the sub picture 82 according to the PC active window control signal, and the PC program active window 83 is displayed as a fifth PC program active window 83c.

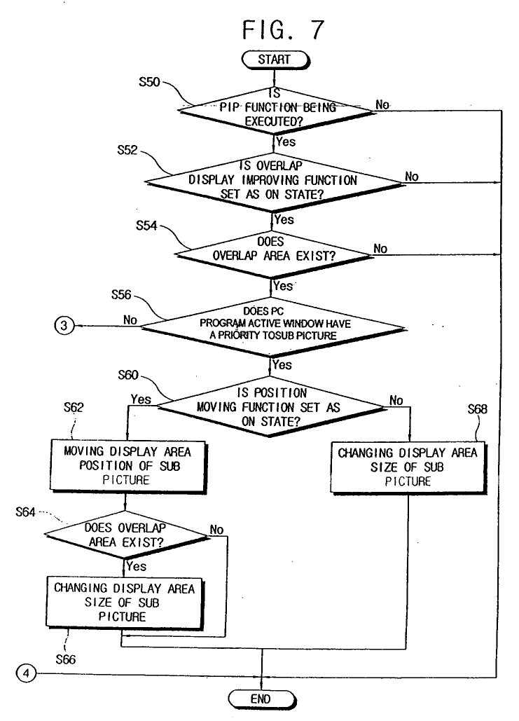

With this configuration, a control flow chart of the display system 300′ according to an embodiment of the present general inventive concept will be described with reference to FIGS. 7, 8, and 9. For purposes of convenience, the control operation of the display apparatus 200′ is illustrated as a solid line, and that of the computer 100′ is illustrated as a dotted line.

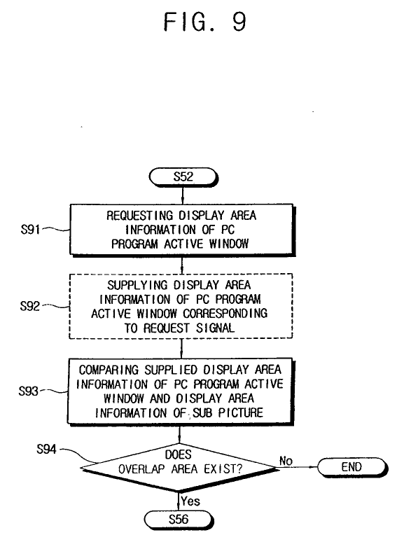

Referring to FIGS. 3, 7, 8, and 9, the display controller 75′ determines whether the display apparatus 200′ currently performs the PIP function at operation S50. When it is determined that the display apparatus 200′ performs the PIP function, the display controller 75′ determines whether the overlap display improving function is set as the on state through the user input part 40′ at operation S52. When it is determined that the overlap display improving function is set as the on state based on the determination result, the display controller 75′ determines whether the overlap area exists between the PC program active window 83 and the sub picture 82 at operation S54. Referring to FIGS. 7 and 9, the operation S54 of determining the existence of the overlap area will be described in detail.

When the overlap display improving function is set as the on state while executing the PIP function, the display controller 75′ requests the display area information of the PC program active window 83 to the computer 100 at operation S91. The computer controller 65′ supplies the display area information of the PC program active window 83 to the display controller 75′ corresponding to the request at operation S92. Then, the display controller 75′ compares the respective display pixel information of the received display area information of the PC program active window 83 and of the display area information of the sub picture 82 detected from the PIP processor 56 at operation S93. The display controller 75′ determines whether the overlap area exists between the sub picture 82 and the PC program active window 83 having the same display area (display pixel), based on the comparison result at operation S94.

Referring back to FIG. 7, when it is determined that the overlap area exists, the display controller 75′ determines whether the PC program active window 83 has a priority with respect to the sub picture 82 based on the information stored in the display storage part 72 at operation S56. When the PC program active window 83 has the priority with respect to the sub picture 82, the display controller 75′ determines whether the position moving function is set as the on state based on the information of the display storage part 72 at operation S60. When the position moving function is set as the on state, the display controller 75′ controls the PIP processor 56 to move the display area position of the sub picture 82 to remove the overlap area at operation S62. Then, the display controller 75′ determines whether a portion of the overlap area still exists between the moved sub picture 82 and the PC program active window 83 at operation S64. When it is determined that a portion of the overlap area still exists, the display controller 75′ controls the PIP processor 56 to change the display area size of the moved sub picture 82 to remove the overlap area at operation S66.

Here, when it is determined that the position moving function is set as the off state at operation S60, the display controller 75′ controls the PIP processor 56 to change the display area size of the sub picture 82 to remove the overlap area at operation S68.

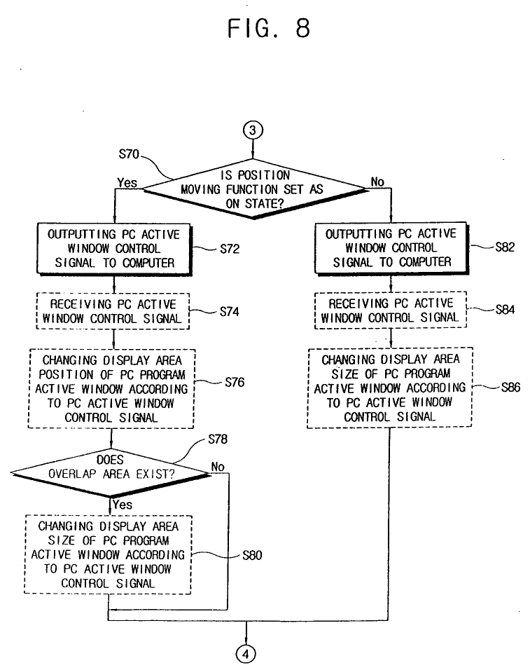

Meanwhile, when it is determined that the PC program active window 83 does not have the priority with respect to the sub picture 82 at the operation S56, operations of FIG. 8 are performed through connections \textcircled{3} and \textcircled{4}. That is, the display controller 75′ determines whether the position moving function is set as the on state based on the information of the display storage part 72 at operation S70. When the position moving function is set as the on state, the display controller 75′ outputs the PC active window control signal to the computer 100′ to move the display area position of the PC program active window 83 and to remove the overlap area based on the display pixel information of the overall displayable area of the display apparatus 200′ and the display area (display pixel information) of the sub picture 82 at operation S72. Then, the computer controller 65′ receives the PC active window control signal at operation S74 and controls the graphic card 30 to move the display area position of the PC program active window 83 according to the received PC active window control signal at operation S76. The display controller 75′ determines whether a portion of the overlap area still exists between the moved PC program active window 83 and the sub picture 82 at operation S78. When it is determined that the portion of the overlap area still exists, the display controller 75′ outputs the PC active window control signal to the computer 100′ to change the display area size of the PC program active window 83 to remove the overlap area. The computer controller 65′ controls the graphic card 30 to change the display area size of the PC program active window 83 according to the PC active window control signal received from the display controller 75′ at operation S80.

Here, when it is determined that the position moving function is set as the off state at operation S70, the display controller 75′ outputs the PC active window control signal to the computer 100′ to change the display area size of the PC program active window 83 so that the overlap area is removed based on the display pixel information of the overall displayable area of the display apparatus 200′ and the display area (display pixel information) of the sub picture 82 at operation S82. Then, the computer controller 65′ receives the PC active window control signal at operation S84, and controls the graphic card 30 to change the display area size of the PC program active window 83 based on the received PC active window control signal at operation S86.

Here, FIG. 9 illustrates the operation S54 which is performed between the operations S52 and S56 to determine the existence of the overlap area. The operations S64 and S78 can be performed through the operations S91 to S94 of FIG. 9.

As described above, the display system 300′ and a control method thereof, and the computer 100′ and the display apparatus 200′ included in the display system 300′ according to the present embodiment may effectively remove or prevent the overlap area between the PC program active window 83 and the sub picture 82 through a simple manipulation (i.e., setting the overlap display improving function as the on state), without key inputs by a user to deal with the overlap area.

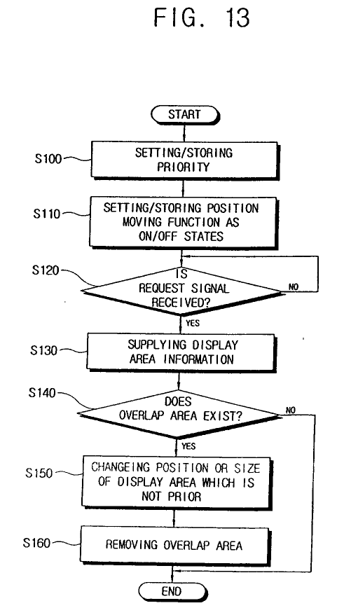

Meanwhile, a control method of a video source and a display apparatus according to an embodiment of the present general inventive concept will be described with reference to FIG. 13.

Referring to FIGS. 2, 3, and 13, the computer 100 (or 100′) and/or the display apparatus 200 (or 200′) receive and store priority information of a PC program active window (main picture) and a sub picture at operation S100. Here, the priority information may be input through an input part of the computer 100 or through an input part of the display apparatus 200. The computer 100 and/or the display apparatus 200 receive on/off setting information of a position moving function of the PC program active window and the sub picture and store the information in a memory at operation S110. The on/off setting information may be also input through the input part of the computer 100 or the display apparatus 200.

The computer 100 and the display apparatus 200 respectively determine whether a predetermined request signal is input from each other at operation S120. That is, in the control method of the video source and the display apparatus according to the present embodiment, the computer 100 may determine whether the request signal is input from the display apparatus 200, or the display apparatus 200 may determine whether the request signal is input from the computer 100. When the request signal is received from one of the computer 100 and the display apparatus, the other one of the computer 100 and the display apparatus 200 supplies the requested display area information to the one of the display apparatus 200 or the computer 100. That is, when the computer 100 receives the request signal, the computer 100 supplies display area information of the PC program active window to the display apparatus 200. When the display apparatus 200 receives the request signal, the display apparatus 200 supplies display area information of the sub picture to the computer 100.

The display apparatus 200 or the computer 100 determines whether the overlap area exists according to the display area information by comparing the supplied display area information (display area information of the PC program active window or of the sub picture) and the display area information recognized at operation S140. That is, when the display apparatus 200 receives the display area information of the PC program active window, the display apparatus 200 determines whether the overlap area exists by comparing the display area information of the sub picture recognized through the PIP processing and the display area information of the PC program active window. When the computer 100 receives the display area information of the sub picture, the computer 100 determines whether the overlap area exists by comparing the display area information of the PC program active window recognized through a video signal supplied to the display apparatus 200 and the display area information of the sub picture.

When it is determined that the overlap area exists, one of the display apparatus 200 and the computer 100 which has determined the existence of the overlap area controls itself or the other one of the display apparatus 200 and the computer 100 to change a display position or size of the PC program active window or the sub picture which does not have the priority at operation S150, based on the priority information and the on/off setting information of the position moving function stored through the operations S100 and S110. Then, the display area characteristics (display position and size) of at least one of the PC program active window and the sub picture which overlaps are changed to remove the overlap area at operation S160.

As described above, the display system, the display apparatus, and the control method of the video source and the display apparatus according to embodiments of the present general inventive concept may effectively remove the overlap area without key inputs by a user to control the overlap area, when the PC program active window of the main picture and the sub picture displayed through the PIP function overlap each other.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display system which comprises a video source to supply a first video signal and a display apparatus to receive the first video signal and a second video signal from an external device and to be displayed as a main picture and a sub picture, respectively, through a picture in picture (PIP) processing, the display system further comprising:
a controller which changes one or more display area characteristics of at least one of a display area of a program active window of the main picture and a display area of the sub picture to remove an overlap area between the display areas of the program active window and the sub picture.

2. The display system according to claim 1, wherein the controller comprises a video source controller which is provided in the video source and requests display area information of the sub picture to the display apparatus and determines whether the overlap area exists by comparing the display area information of the sub picture received corresponding to the request and display area information of the program active window.

3. The display system according to claim 1, wherein the controller comprises a display controller which is provided in the display apparatus and supplies the display area information of the sub picture to the video source based on the PIP processing, when a request signal is received from the video source.

4. The display system according to claim 1, wherein the display area characteristic comprises one of a location with respect to the screen, a size of the one of the main picture and the sub picture with respect to the other one of the main picture and the sub picture, and a resolution of the one of the main picture and the sub picture.

5. The display system according to claim 1, wherein the controller comprises:
an overlap display improving function setter to set an overlap display improving function as an on state to improve a display of the overlap area, and determines whether the overlap area exists and changes at least one of the display areas of the program active window and the sub picture, when the overlap display improving function is set as the on state through the overlap display improving function setter.

6. The display system according to claim 1, wherein the controller comprises:
a priority setter to set a priority of the program active window and the sub picture, and stores priority information of the program active window and the sub picture which are set through the priority setter.

7. The display system according to claim 1, wherein the controller comprises:
a position moving function setter which sets a position moving function of the program active window and the sub picture as on/off states, and stores on/off setting information of the position moving function set through the position moving function setter.

8. The display system according to claim 1, wherein the main picture comprises a frame area of the program active window which visually divides the program active window and a display area boundary thereof.

9. A display apparatus which receives a plurality of video signals and displays the video signals as a main picture and a sub picture through a picture in picture (PIP) processing, the display apparatus comprising:
a controller which supplies display area information of the sub picture based on the PIP processing to a video source supplying one of the video signals to be displayed as the main picture, and changes at least one of a position and a size of the display area of the sub picture according to a sub picture control signal when the sub picture control signal is input from the video source.

10. The display apparatus according to claim 9, wherein the video source and the controller communicate with each other through a display data channel (DDC) communication line.

11. The display apparatus according to claim 9, wherein the controller comprises:
a priority setter to set a priority of a program active window of the main picture and the sub picture, and to store priority information of the program active window and the sub picture which are set through the priority setter.

12. The display apparatus according to claim 9, wherein the controller comprises:
a position moving function setter to set a position moving function of a program active window of the main picture and the sub picture as on/off states, and to store on/off setting information of the position moving function set through the position moving function setter.

13. A method of controlling a video source which supplies a first video signal, and a display apparatus which receives the first video signal from the video source and a second video signal from an external device to display them through a picture in picture (PIP) processing, the method comprising:
displaying the first and second video signals as a main picture and a sub picture, respectively, through a picture in picture (PIP) processing; and
changing one or more display area characteristics of at least one of a display area of a program active window of the main picture and a display area of the sub picture to remove an overlap area between the display area of the program active window and the display area of the sub picture.

14. The method according to claim 13, further comprising:
requesting display area information of the sub picture by the video source; and
determining whether the overlap area exists by comparing the display area information of the sub picture received corresponding to the request and display area information of the program active window based on the first video signal supplied to the display apparatus.

15. The method according to claim 14, further comprising:
supplying the display area information of the sub picture based on the PIP processing to the video source when the request signal is received from the video source.

16. The method according to claim 13, further comprising:
receiving and storing priority information of the program active window and the sub picture, and wherein
the changing at least one of the display areas of the program active window and the sub picture further comprises changing the display area of one of the program active window and the sub picture which is not prior to the other based on the stored priority information, when the overlap area exists.

17. The method according to claim 13, further comprising:
setting a position moving function of the program active window and the sub picture as on/off states, and wherein
the changing at least one of the display areas of the program active window and the sub picture comprises controlling one of a video signal supply of the video source and a PIP processor which performs the PIP processing, to move a display area position of one of the program active window and the sub picture which is not prior to the other based on the priority information and to remove the overlap area, when the overlap area exists and the position moving function is set as the on state.

18. The method according to claim 13, further comprising:
requesting a display area information of the program active window to the video source; and
determining whether the overlap area exists by comparing the display area information of the program active window received from the video source corresponding to the request and a display area information of the sub picture.

19. The method according to claim 18, wherein:
the video source comprises a video signal supply which outputs the first video signal; and
the determining of the existence of the overlap area comprises receiving the display area information of the program active window supplied by the video source which has received the request signal, based on the video signal supply.

20. The method according to claim 13, wherein the program active window of the main picture comprises a frame area of the program active window which visually divides a display area boundary of the program active window, and the sub picture comprises a frame area of the sub picture which visually divides a display area boundary of the sub picture.

21. A display apparatus comprising:
an input unit to receive a first video signal and a second video signal; and
a controller to automatically change a characteristic of one of a main picture and a sub picture corresponding to the first video signal and the second video signal, respectively, to be displayed on a screen according to a priority on the main picture and the sub picture.

22. The display apparatus according to claim 21, wherein the characteristic comprises one of a location with respect to the screen, a size of the one of the main picture and the sub picture with respect to the other one of the main picture and the sub picture, and a resolution of the one of the main picture and the sub picture.

23. A display apparatus, comprising:
a processing unit to receive a first signal and a second signal to generate a main picture and a sub picture from the first signal and the second signal, respectively, to be displayed on a screen; and
a controller to change at least one display area characteristic of at least one of display areas of the main picture and the sub picture corresponding to the first video signal and the second video signal with respect to the screen to remove an overlap area between the display areas of the program active window and the sub picture.

24. The display apparatus according to claim 23, wherein:
the processing unit receives information on the display area characteristic of the main picture corresponding to the first signal; and
the controller controls the processing unit to generate the main picture and the sub picture according to the first signal, the second signal, and the received information.

25. A display apparatus, comprising:
a processing unit to receive a first signal and a second signal to generate a main picture and a sub picture from the first signal and the second signal to be displayed on a first position and a second position of a screen, respectively; and
a controller to determines whether there is an overlap area between the first position and the second position, to change at least one of the first position and the second position into a third position according to the determination of whether there is the overlap area, and to control the processing unit to generate the main picture and the sub picture to be displayed on corresponding ones of the changed one of the first position and the second position and the other one of the first position and the second position.

26. The display apparatus according to claim 25, wherein the changed one of the first position and the second position is different from the one of the first position and the second position in one of size and location.

27. The display apparatus according to claim 25, wherein:
the main picture comprises a first frame area and a first image disposed within the first frame;
the sub picture comprises a second frame area and a second image disposed within the second frame; and
the controller determines that there is the overlap area when the first image and the second image overlap.

28. The display apparatus according to claim 27, wherein the controller determines that there is no overlap area when the first frame area and the second frame area overlap.

29. The display apparatus according to claim 25, wherein:
the main picture comprises a first frame area and a first image disposed within the first frame;
the sub picture comprises a second frame area and a second image disposed within the second frame; and
the controller determines that there is no overlap area when the first frame area and the second frame area overlap.

30. A display system, comprising:
a display part having a screen;
a processing unit to receive a first signal and a second signal, and to determine a first portion of the screen and a second portion of the screen to correspond to the first signal and the second signal; and
a controller to determine an overlap area between the first portion and the second portion, to determine a third portion of the screen to correspond to one of the first portion and the second portion, and to generate a main picture and a sub picture according to the first signal, the second signal, and the third portion of the screen.

31. The display system according to claim 30, wherein the controller determines the third position to be disposed between a boundary of the screen and a boundary of one of the first portion and the second portion.

32. The display system according to claim 30, wherein the third portion of the screen is smaller than one of the first portion and the second portion.

33. The display system according to claim 30, wherein the third portion of the screen is moved with respect to one of the first portion and the second portion.

34. A display system comprising:
a host to generate a first signal; and
a display apparatus having a processing unit to receive the first signal input from the host and a second signal input from an external device to generate a main picture and a sub picture from the first signal and the second signal, respectively, to be displayed on a screen, and having a controller to change at least one of display area characteristics of at least one of a display area of the main picture and a display area of the sub picture with respect to the screen to remove an overlap area between the display areas of the program active window and the sub picture.

35. The display system according to claim 34, wherein the host and the display apparatus are formed in a single body.

36. The display system according to claim 34, wherein the display apparatus is connected to the external device through Internet or one of wire and wireless communication.

37. The display system according to claim 34, wherein the display apparatus receives first information on the display area characteristic of the display area of the main picture from the host, determines second information on the display area characteristic of the display area of the sub picture according to a predetermined value with respect to the screen, and generates the main picture and the sub picture according to the first information and the second information.

38. The display system according to claim 37, wherein the processing unit does not receive the second information from the external device.
